(19) United States
(12) Patent Application Publication
(10) Pub. No.: US 2023/0136004 A1
(43) Pub. Date: May 4, 2023

(54) SYSTEM AND METHOD OF QUOORI FILMSTRIP FEATURE

(71) Applicant: Daniel Stanley, Bishop's Stortfoed (GB)

(72) Inventors: Daniel Stanley, Bishop's Stortford (GB); Torsten Martin Sigwart, Hamburg (DE)

(73) Assignee: Quoori Inc., San Francisco, CA (US)

(21) Appl. No.: 17/515,453

(22) Filed: Oct. 30, 2021

(51) Int. Cl. G06F 3/0488; G06F 3/0482; G06F 3/0485

(52) U.S. Cl. CPC G06F 3/04883; G06F 3/0482; G06F 3/0485

(57) ABSTRACT

A system for displaying user applications is provided comprising a mobile device and a display application executing thereon. The system receives a manual swiping action on a home button through a navigation bar of a graphical user interface, the interface comprising at least a row of selectable objects at a bottom area of a display of the device. The system also displays selectable objects representing presently running applications on a first side of the interface. The system also displays selectable objects representing presently not running but suggested applications on a second side of the interface. The received manual swiping action is in one of a leftward and a rightward direction. The display application and the operating system execute on a mobile device. The selectable objects representing both the running user applications and the not running but suggested user applications are displayed in a horizontal row manner by the interface.

### FIELD OF THE INVENTION

The present disclosure is in the field of mobile device electronic utilities and tools. More particularly, the present disclosure provides an application that promotes a user to quickly view listings of presently running applications and presently not running but suggested applications and quickly select one of the applications from either listing to use.

### BACKGROUND

Mobile device users may access many applications simultaneously. Because such devices are often used when a user is busy and occupied, for example while moving on foot or in a vehicle, ease of access to applications on a mobile device is important for reasons of convenience, safety, and security. Rapidly moving between applications while maintaining attention elsewhere or while being otherwise occupied is important to such device users.

### BRIEF DESCRIPTION OF THE FIGURES

FIG. 1 is a block diagram of a system of quoori filmstrip feature in accordance with an embodiment of the present disclosure.

FIG. 2 is an image of an interface of a quoori filmstrip feature in accordance with an embodiment of the present disclosure.

FIG. 3 is an image of an interface of a quoori filmstrip feature in accordance with an embodiment of the present disclosure.

FIG. 4 is an image of an interface of a quoori filmstrip feature in accordance with an embodiment of the present disclosure.

### DETAILED DESCRIPTION

Systems and methods described herein provide an interface for use on mobile devices that allows a user to view and select presently running as well as not presently running but suggested user applications. The interface, which is a component of an application provided herein, allows for quick swiping and auto scrolling between user applications, both applications presently running and applications not presently running but suggested for use. The application, which is referred to herein and may be referred to commercially as a filmstrip application at least because of its scrolling characteristics, may execute on a Quoori operating system or other operating systems on mobile devices or on other electronic devices.

Applications that are presently not running but suggested for use by the system may be selected for display based on their frequent previous use or frequent association with other applications or data. The system may also detect via at least machine learning a potential need based on other identified patterns of user behavior from the past.

When the user swipes left or right on a draggable area of the interface, a row of icons or other selectable objects appears at the bottom of the display. The row format includes objects representing both presently running and not presently running but suggested user applications. The displayed objects in the row can be scrolled in a leftward and rightward direction through user touching of the row and swiping. The object in the center of the row at a given moment will be altered in appearance.

If the user touches and maintains contact with the row at either the right or left extreme endpoint, i.e., either the right or left end of the row, the objects will begin scrolling or moving in one direction or the other depending on which end of the row the user is touching. The row will continue to move in the leftward or rightward direction until the user discontinues tactile contact, i.e., removes his or her finger from contact with the surface of the screen. The system is configurable such that when the user removes his/her finger from the right or left end of the row that is presently scrolling, the user application that is presently at the center position and thus altered in appearance will maximize if already running or be executed and caused to begin running and maximize if not presently running.

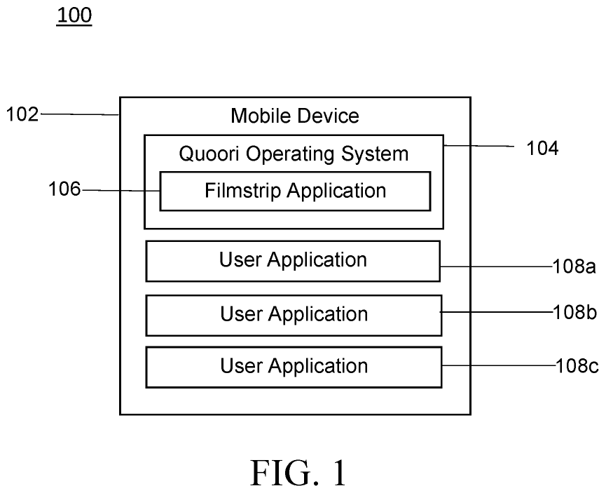

Turning to the figures, FIG. 1 is a block diagram of a system for easing access to user applications according to an embodiment of the present disclosure. A system 100 is provided herein and illustrated that includes a mobile device 102 and an operating system 104 that may be a Quoori operating system. The system 100 also includes a filmstrip application 106 that executes most of the functionality of systems and methods provided herein. The system 100 also comprises a plurality of user applications 108a-n that are subject to the methods provided herein

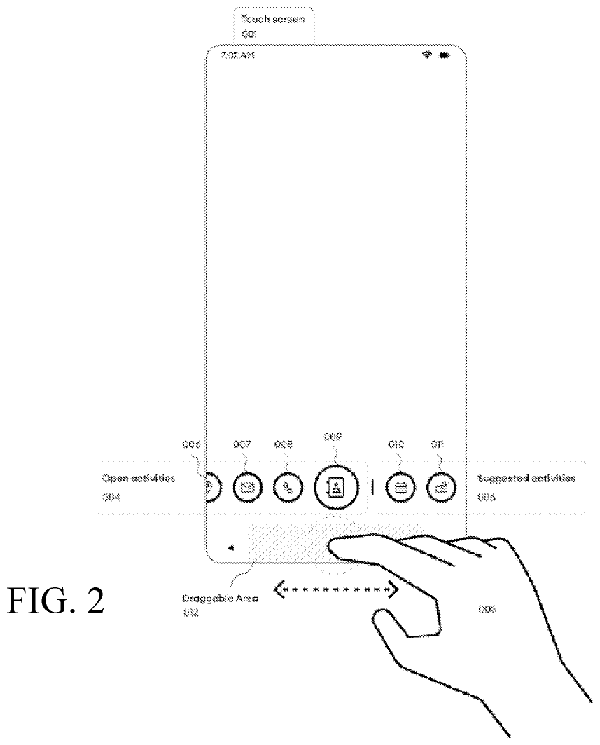

FIG. 2 is a diagram of the interface wherein objects for user applications 108a-n are displayed in a row fashion across a bottom area of the interface. The draggable area of the interface is shown with the user's finger shown tactiley manipulating the interface to move objects back and forth. As noted, the object presently at the center of the row is displayed in an altered manner.

In FIG. 2, while open activities (certain presently running user applications 108a-n) are shown on a left side of the row and suggested activities (certain other user applications 108a-n that are presently not running but are suggested as described above) are shown on the right side of the row, in embodiments, open and suggested activities may not be presented in this manner. In other embodiments, open and suggested activities may appear in different orders or arrangements.

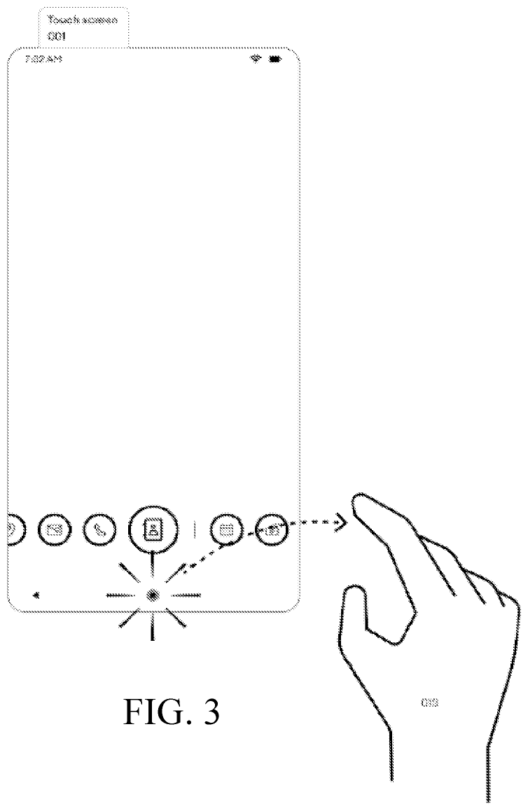

FIG. 3 illustrates the user removing his/her finger from tactile contact with the row such that the user application associated with the object presently in the center position of the row and hence altered in appearance is maximized if presently running. If not presently running, the user application associated with the object presently in the center position is executed and caused to begin running and is maximized. This process is discussed above.

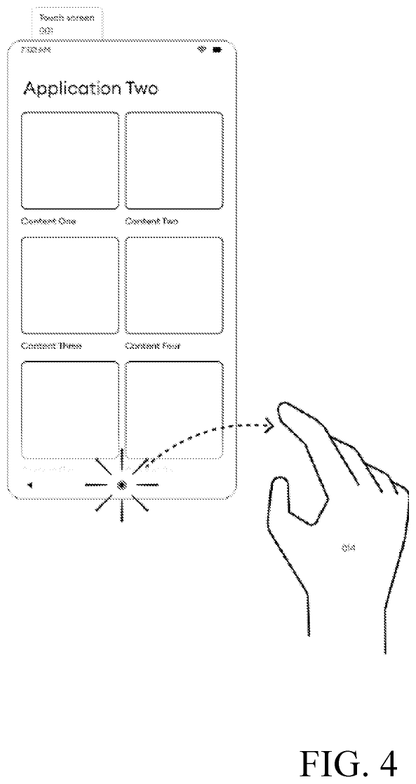

Similar to FIG. 3, FIG. 4 illustrates the user removing his/her finger from tactile contact with the row. However, in FIG. 4, the user is moving between focused activities within a user application 108a-n. For example, with a user application 108a that is a word processing application, the user may be switching between open documents that he/she is working on simultaneously. Systems and methods promote ease of movement between not just user applications 108a-n, but between documents or other activities with a particular user application 108a.

In embodiments, systems and methods provided herein may execute on hardware components other than mobile devices. Tablet computers, laptop computers, and certain non-mobile devices such as desktop computers may also host systems and methods provided herein.

As discussed above, when a particular object is presently at a center position of the row of objects representing user applications 108a-n, the object is altered in appearance. Such alteration may comprise changing in size and/or color and/or shape. The object may glow or pulsate. The object may be altered in other manners.

While the term “suggested” as used herein has generally referred to user applications 108a-n that are not presently running or executing but suggested by the filmstrip application 106 for use, it bears noting that all user applications 108a-n, whether presently running or not running, are suggested based on the appearance of their corresponding objects in the interface. Whether running or not running, the appearance of an object in the interface is a suggestion that the user application 108a-n associated with the object be used.

In an embodiment, a system for displaying user applications is provided comprising a mobile device and a display application executing thereon. The system receives a manual swiping action on a home button through a navigation bar of a graphical user interface, the interface comprising at least a row of selectable objects at a bottom area of a display of the device. The system also displays selectable objects representing presently running applications on a first side of the interface. The system also displays selectable objects representing presently not running but suggested applications on a second side of the interface. The received manual swiping action is in one of a leftward and a rightward direction. The display application executes on a Quoori operating system. The display application and the operating system execute on a mobile device. The selectable objects representing both the running user applications and the not running but suggested user applications are displayed in a horizontal row manner by the interface. Based on leftward and rightward manual swiping action, the horizontally displayed objects move in a leftward direction or rightward direction, respectively. The selectable objects auto scroll based on detection of persistent physical user tactile contact at one of a right extreme and a left extreme of the interface.

In another embodiment, a system for easing access to user applications is provided comprising a mobile device and a display application executing thereon. The system horizontally displays objects representing user applications in a row along a bottom area of an interface. The system moves the objects one of rightward and leftward along the row based on detection of one of rightward and leftward swiping action. The system alters an appearance of a first object presently situated in a center position of the row. Upon detection of removal of physical user tactile contact with the row, the system one of maximizes and positions in a foreground of a display of the device a first user application that is presently running and executes, maximizes, and positions in the foreground the first user application that is presently not running but suggested for use. The display application executes on a Quoori operating system. The display application and the operating system execute on a mobile device. Objects representing user applications that are presently running are grouped together in a horizontal manner on a left area of the row and objects representing user applications that are presently not running but suggested for use are grouped together in a horizontal manner on a right area of the row. Objects representing user applications that are presently running are alternatively grouped together in a horizontal manner on a right area of the row and objects representing user applications that are presently not running but suggested for use are alternatively grouped together in a horizontal manner on a left area of the row. Alteration to the appearance of the first object comprises at least one of altering a size of the first object, altering a color of the first object, altering a shape of the first object, and causing the first object to at least one of glow and pulsate.

In yet another embodiment, a method for displaying user applications is provided. The method comprises a mobile device receiving a manual swiping action on a home button through a navigation bar of a graphical user interface, the interface comprising at least a row of selectable objects at a bottom area of a display of the device. The method also comprises the device displaying selectable objects representing presently running applications on a first side of the interface. The method also comprises the device displaying selectable objects representing presently not running but suggested applications on a second side of the interface. The received manual swiping action is in one of a leftward and a rightward direction. The selectable objects representing both the running user applications and the not running but suggested user applications are displayed in a horizontal row manner by the interface. Based on leftward and rightward manual swiping action, the horizontally displayed objects move in a leftward direction or rightward direction, respectively. The selectable objects auto scroll based on detection of persistent physical user tactile contact at one of a right extreme and a left extreme of the interface. The mobile device, upon detection of removal of the physical user tactile contact, executes actions comprising one of maximizing and positioning in a foreground of a display a first user application that is presently running and executing, maximizing, and positioning in the foreground the first user application that is presently not running but suggested for use, the first user application presently represented by a first selectable object presently located at a center position of the interface. The device alters an appearance of the first selectable object, the altering comprising at least one of changing a size of the first object, changing a color of the first object, changing a shape of the first object, and causing the first object to at least one of glow and pulsate.

What is claimed is:

1. A system for displaying user applications, comprising:
a mobile device; and
a display application executing thereon that:
receives a manual swiping action on a home button through a navigation bar of a graphical user interface, the interface comprising at least a row of selectable objects at a bottom area of a display of the device,
displays selectable objects representing presently running applications on a first side of the interface, and
displays selectable objects representing presently not running but suggested applications on a second side of the interface.

2. The system of claim 1, wherein the received manual swiping action is in one of a leftward and a rightward direction.

3. The system of claim 1, wherein the display application executes on a Quoori operating system.

4. The system of claim 3, wherein the display application and the operating system execute on a mobile device.

5. The system of claim 1, wherein the selectable objects representing both the running user applications and the not running but suggested user applications are displayed in a horizontal row manner by the interface.

6. The system of claim 5, wherein based on leftward and rightward manual swiping action, the horizontally displayed objects move in a leftward direction or rightward direction, respectively.

7. The system of claim 5, wherein the selectable objects auto scroll based on detection of persistent physical user tactile contact at one of a right extreme and a left extreme of the interface.

8. A system for easing access to user applications, comprising:
a mobile device; and
a display application executing thereon that:
horizontally displays objects representing user applications in a row along a bottom area of an interface,
moves the objects one of rightward and leftward along the row based on detection of one of rightward and leftward swiping action, respectively,
alters an appearance of a first object presently situated in a center position of the row, and
upon detection of removal of physical user tactile contact with the row, one of maximizes and positions in a foreground of a display of the device a first user application that is presently running and executes, maximizes, and positions in the foreground the first user application that is presently not running but suggested for use.

9. The system of claim 8, wherein the display application executes on a Quoori operating system.

10. The system of claim 8, wherein the display application and the operating system execute on a mobile device.

11. The system of claim 8, wherein objects representing user applications that are presently running are grouped together in a horizontal manner on a left area of the row and objects representing user applications that are presently not running but suggested for use are grouped together in a horizontal manner on a right area of the row.

12. The system of claim 11, wherein objects representing user applications that are presently running are alternatively grouped together in a horizontal manner on a right area of the row and objects representing user applications that are presently not running but suggested for use are alternatively grouped together in a horizontal manner on a left area of the row.

13. The system of claim 8, wherein alteration to the appearance of the first object comprises at least one of altering a size of the first object, altering a color of the first object, altering a shape of the first object, and causing the first object to at least one of glow and pulsate.

14. A method for displaying user applications, comprising:
a mobile device receiving a manual swiping action on a home button through a navigation bar of a graphical user interface, the interface comprising at least a row of selectable objects at a bottom area of a display of the device;
the device displaying selectable objects representing presently running applications on a first side of the interface; and
the device displaying selectable objects representing presently not running but suggested applications on a second side of the interface.

15. The method of claim 14, wherein the received manual swiping action is in one of a leftward and a rightward direction.

16. The method of claim 14, wherein the selectable objects representing both the running user applications and the not running but suggested user applications are displayed in a horizontal row manner by the interface.

17. The method of claim 16, wherein based on leftward and rightward manual swiping action, the horizontally displayed objects move in a leftward direction or rightward direction, respectively.

18. The method of claim 14, wherein the selectable objects auto scroll based on detection of persistent physical user tactile contact at one of a right extreme and a left extreme of the interface.

19. The method of claim 18, further comprising the device, upon detection of removal of the physical user tactile contact, executing actions comprising one of maximizing and positioning in a foreground of a display a first user application that is presently running and executing, maximizing, and positioning in the foreground the first user application that is presently not running but suggested for use, the first user application presently represented by a first selectable object presently located at a center position of the interface.

20. The method of claim 19, further comprising the device altering an appearance of the first selectable object, the altering comprising at least one of changing a size of the first object, changing a color of the first object, changing a shape of the first object, and causing the first object to at least one of glow and pulsate.
